(19) United States
(12) Patent Application Publication
(10) Pub. No.: US 2020/0070829 A1
(43) Pub. Date: Mar. 5, 2020

(54) METHOD AND APPARATUS FOR INTERIOR NOISE SENSING FOR EFFICIENT NOISE AND VIBRATION PERFORMANCE

(71) Applicant: GM GLOBAL TECHNOLOGY OPERATIONS LLC, DETROIT, MI (US)

(72) Inventors: William K. Martinez, Hazel Park, MI (US); Wallace J. Hill, Commerce Township, MI (US); Kevin A. Smith, Chelsea, MI (US)

(21) Appl. No.: 16/120,773

(22) Filed: Sep. 4, 2018

(51) Int. Cl. B60W 30/18; H04R 1/40; H04R 3/00; H04R 29/00

(52) U.S. Cl. CPC B60W 30/18; H04R 1/406; H04R 3/005; B60W 2710/08; H04R 2499/13; B60W 2520/10; H04R 29/001

(57) ABSTRACT

The present application generally relates noise and vibration mitigation in a vehicle. More specifically, the application teaches a system and method for applying a noise and vibration constraint to a vehicle subsystem, measuring a sound level within the vehicle cabin, determining the sound level exceeds a threshold level making the noise constraint redundant and removing the noise constraint in response to the sound level exceeding the threshold level.

### BACKGROUND OF THE INVENTION

### Field of the Technology

The subject of the disclosure relates generally to noise and vibration control systems of an automobile vehicle, and more particularly, the use of vehicle interior audio sensors and other vehicle sensors to actively evaluate masking noise relative to threshold values and remove noise and vibration constraints thereby increasing vehicle efficiency.

### Background Information

Vehicle subsystems typically include noise and vibration constraints in order to reduce cabin noise and increase occupant comfort. For example, a rear differential control module may have noise and vibration constraints that lock clutches to avoid gear rattle or limit torque to avoid hypoid gear noises. These constraints affect efficiency and all-wheel drive performance of the vehicle in order to make noise and vibration levels acceptable. However, there are occasions when these noise and vibration constraints are applied in situations where the application is unnecessary. These situations may include open windows during highway driving, playing of the audio system at a high volume, autonomous driving where the vehicle is empty, etc. During these situations, the vehicle may apply noise and vibration constraints, thereby reducing performance of the vehicular systems, when there will be no appreciable benefit to vehicle occupants. It would be desirable to be able to remove noise and vibration constraints in situations where there is no appreciable benefit.

### SUMMARY

Embodiments according to the present disclosure provide a number of advantages. For example, embodiments according to the present disclosure may enable independent validation of autonomous vehicle control commands to aid in diagnosis of software or hardware conditions in the primary control system. Embodiments according to the present disclosure may thus be more robust, increasing customer satisfaction.

In accordance with an aspect of the present invention, a method for generating a spatially rendering of an audio program comprising applying a noise control to a vehicle subsystem, determining a cabin sound level, comparing the cabin sound level to a threshold value, removing the noise control in response to the cabin sound level exceeding the threshold value, and operative the vehicle subsystem without the noise control.

In accordance with another aspect of the present invention, a method comprising operating a vehicle subsystem in response to a noise constraint, determining a sound level in a vehicle cabin, removing the noise constraint in response to the sound level exceeding a threshold, and operating the vehicle subsystem in an absence of the noise constraint.

In accordance with another aspect of the present invention, an apparatus comprising a vehicle subsystem, a first sound sensor for detecting a first cabin sound level at a first location and generating a first sound data signal, a sound processor for receiving the first sound data signal and generated a control signal in response to the first sound data signal exceeding a threshold, and a vehicle controller for controlling the vehicle subsystem, the vehicle controller further operative to remove a noise control restrain from the vehicle subsystem in response to the control signal.

The above advantage and other advantages and features of the present disclosure will be apparent from the following detailed description of the preferred embodiments when taken in connection with the accompanying drawings.

### BRIEF DESCRIPTION OF THE DRAWINGS

FIG. 1 shows a diagram showing an exemplary environment of a vehicle cabin for implementing the present disclosed systems and methods.

FIG. 2 shows a block diagram depicting an exemplary system for interior noise sensing for efficient noise and vibration performance.

FIG. 3 shows a flow chart depicting an exemplary method for interior noise sensing for efficient noise and vibration performance.

FIG. 4 shows a flow chart illustrating another exemplary method for interior noise sensing for efficient noise and vibration performance.

The exemplifications set out herein illustrate preferred embodiments of the invention, and such exemplifications are not to be construed as limiting the scope of the invention in any manner.

### DETAILED DESCRIPTION

The following detailed description is merely exemplary in nature and is not intended to limit the disclosure or the application and uses thereof. Furthermore, there is no intention to be bound by any theory presented in the preceding background or the following detailed description. For example, the audio sensor and playback apparatus of the present invention has particular application for use on a vehicle. However, as will be appreciated by those skilled in the art, the sensor and playback apparatus of the invention may have other applications in systems outside of vehicles.

Modern vehicles sometimes include various active safety and control systems, such as collision avoidance systems, adaptive cruise control systems, lane keeping systems, lane centering systems, noise and vibration suppression systems, etc., where vehicle technology is moving towards semi-autonomous and fully autonomous driven vehicles. For example, noise and vibration suppression systems are operative to detect situations where vehicle sound or vibrations may be unpleasant for the vehicle occupants. In this situation, the noise and vibration suppression systems may be operative to change the operating characteristics of the vehicle in order to reduce the sound or vibration, such as changing the timing of a vehicle engine in order to reduce combustion noise or vibration. Alternatively, the noise and vibration suppression system may actively play sounds through the audio system, which mask or cancel the unpleasant noise, such as playing a noise cancelling frequency to eliminate booming noise caused by engine firing disturbance.

A problem arises when the vehicle is operated in an autonomous mode when the vehicle is unoccupied or when a vehicle occupant is operating a vehicle in a manner with high cabin noise, such as with an open window, operating at highway speeds, ventilation systems operating at maximum capacity or with a sound system above a certain level. A method and system are presently described for using vehicle microphones to actively evaluate cabin noise relative to threshold values and remove noise and vibration constraints to allow vehicle to perform more efficiently. For example, the system may be operative to determine that the cabin noise level exceeds a certain threshold and the system may then remove dithering controls allowing the electric vehicle motors to operate more efficiently. Existing active noise cancellation, Bluetooth or other microphones can be used to detect cabin noise and intelligently control noise and vibration constraints based on measurements of background noises observed in the cabin.

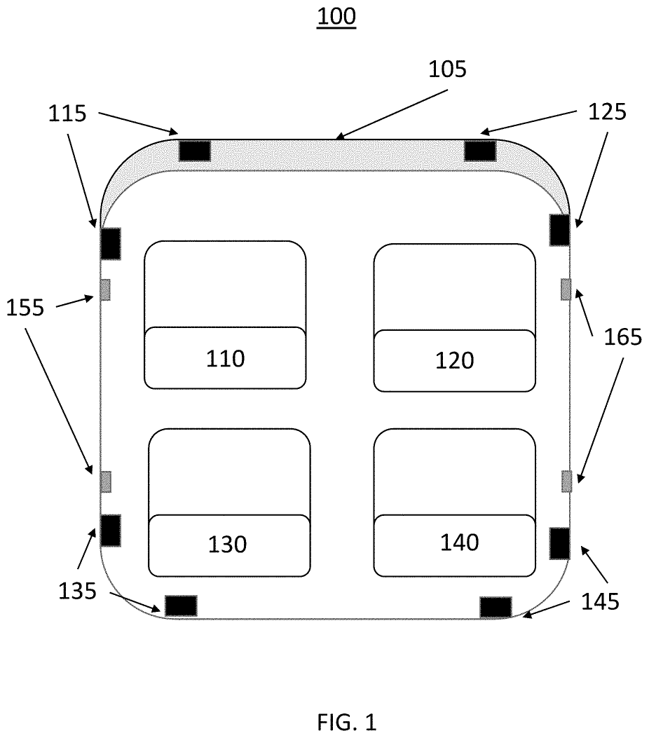

Turning now to FIG. 1 a diagram showing an exemplary environment 100 of a vehicle cabin 105 for implementing the present disclosed systems and methods is shown. The exemplary vehicle cabin 105 is shown having four seating positions, however, the system and method of the present application are not limited to four seating positions. Two, four, six or more searing positions may be used effectively. The four exemplary seating positions are the front left or driver's position 110, the front right 120 position, the rear left 120 position and the rear right position 140. In this exemplary embodiment, each of the four corners of the vehicle cabin 105 are provided with a pair of speakers 115, 125, 135, 145. The speaker configuration is variable and may be altered with the present system and method being equally effective. For example, one speaker may be employed at each corner, or 10 speakers may be employed throughout the cabin as part of an infotainment system. The speaker configuration may be used to play active noise configuration audio used to cancel or obviate vehicle noise.

The vehicle cabin 105 may further be equipped with a number of microphones 155, 165. The microphones may be used to detect ambient noise levels with the vehicle cabin or within sections of the vehicle cabin. For example, the method and system may determine cabin ambient noise levels using audio amplitudes and determine if the sound is originating from the front left zone of the vehicle and therefore cancel out noise originating in other zones in order to better recognize the speech of the speaker. In addition, the microphones 155, 165 may be used as part of a noise cancellation system. For example, sound originating from one section of the vehicle may be detected by a microphone 155 and a canceling sound way may then be generated by the appropriate adjacent speaker.

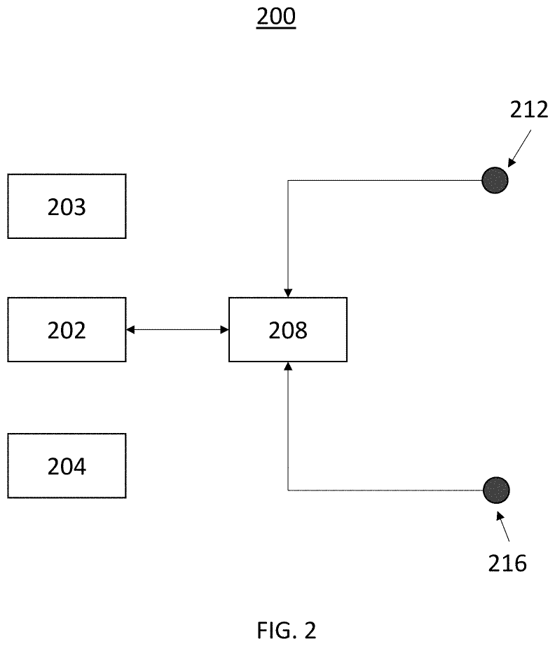

Turning now to FIG. 2, a block diagram depicting an exemplary system for interior noise sensing for efficient noise and vibration performance 200 is shown. The system 200 may include a first sound sensor 212, a second sound sensor 216, an audio processor 208, a vehicle controller 202, a first noise source 203 and a second noise source 204.

The first noise source 203 and the second noise source 204 may include systems that are controllable by the vehicle controller 202 in order to reduce noise and vibration. For example, these sources 203, 204 may include electric motors wherein the electric motor noise may be reduced by dithering calibration to reduce tonal noise. However, dithering calibration of an electric motor may decrease efficiency. The sources 203, 204 may also include a regenerative braking system wherein the amount of regenerative braking may be limited to lower tonal noises, and thereby further decreasing efficiency. Cooling fans, such as those installed in conjunction with a vehicle battery pack may have their speeds limited in order to reduce noise at the expense of cooling efficiency and vehicle range. In addition, electronic cooling pumps, such as water pumps or the like, may be constrained in order to reduce noise and vibration by reducing operating speeds in order to avoid the excitation of system resonances or structure born noises. This reduction of cooling pump speed results in decreased cooling performance and efficiency and therefore reduced vehicle operating performance. HVAC heating pumps may be operated at reduced pump speed to lower tonal noise with reduced cabin heating performance. Exterior sensor maintenance, for example, cameras for autonomous vehicle operation, LIDAR or radar antenna cleaning and maintenance frequency may be limited to reduce operational noises at the cost of decreased sensor efficiency. Combustion noise may be controlled by spark retarding or timing adjustment resulting in decrease fuel economy and combustion efficiency. Noise originating at the rear differential module may be reduced by locking clutches in order to avoid great rattle, limit torque to avoid hypoid gear noises. This may also result in deceased vehicle efficiency and performance. Engine cooling fan noise may be reduced by removing speed setting constraints resulting in decreased engine cooling performance.

The first sound sensor 212 and the second sound sensor 216 may be located in the vehicle cabin and be used to determine an interior noise level. In an exemplary embodiment, the first sound sensor 212 may be located at the front on the vehicle cabin and the second sound sensor may be located at the back on the vehicle cabin in order to measure and determine sounds levels at different locations within the vehicle cabin. More than two sound sensors may be used, or a single sound sensor used, in order to increase accuracy or decrease system costs as design requirements dictate. Typically, the first sound sensor 212 and the second sound sensor 216 would be used to detect noise originating from some of the previously listed noises sources. In this exemplary embodiment, the first sound sensor 212 and the second sound sensor may be used to detect additional noise sources, such as open windows, entertainment systems playing above a threshold volume level, and wind and road noise. If it is determined that the cabin noise level exceeds a level that would mask vehicle generated noise sources, the audio processor 208 may generated a control signal indicating this cabin noise level to the vehicle controller 202. The vehicle controller 202 may then elect to relax current noise and vibration constraints in order to increase vehicle performance and efficiency.

In an exemplary embodiment, the first noise source 203 may be an electric motor used for propelling an electric vehicle. Under some conditions, the electric motor may generate noises and/or vibrations which are unpleasant for the occupants of the vehicle. For example, the rotational speed of the electric motor may interact with other motor sounds to generate undesirable harmonic frequencies, or beating. Likewise, under heavy load, the electric motor may generate other undesirable noises. To address this problem, dithering is applied to the motor, which is a form of noise used to randomize generated frequencies and break up periodic harmonic tones. This has the disadvantage of reducing the efficiency of the electric motor for both propelling the vehicle and energy usage. However, when the interior noise level in the cabin is at a level that would mask the undesirable noises caused by the electric motor, the dithering is superfluous.

In this exemplary embodiment, the first sound sensor 212 is operative to generate a data associated with the interior cabin noise and couple this data to the audio processor 208. The audio processor is operative to determine the interior cabin sound level and to determine if the interior cabin sound level exceeds a threshold which would mask vehicle noises, such as the electric motor sounds. If the interior cabin sound level exceeds the threshold, a control signal is coupled to the vehicle controller 202. The control signal may be generated in response to the threshold being exceeded, or a data flag can be set by the audio processor 208 and the control signal may be coupled to the vehicle controller 202 in response to a request by the vehicle controller 202. The vehicle controller may then reduce the dithering applied to the motor in response to the control signal.

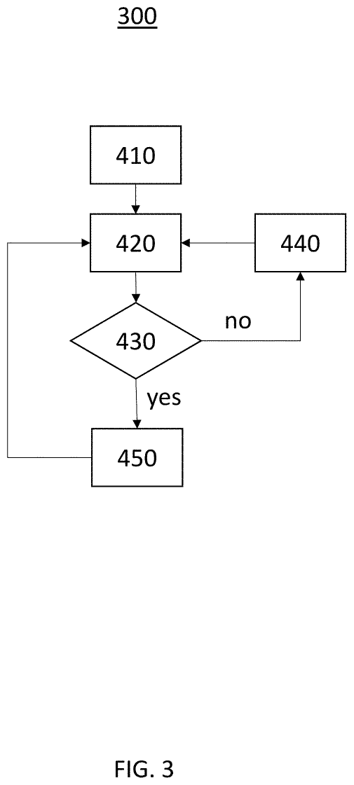

Turning now to FIG. 3, a flow chart depicting an exemplary method for interior noise sensing for efficient noise and vibration performance 300 is shown. The method is first operative to apply noise and vibration control to a vehicle subsystem 410. The method is then operative to sense a sound level 420 where the sound level may be a sound level in a vehicle cabin. The sound level may be determined in response to a single sound measurement or may be calculated from a plurality of sound measurements distributed spatially or over a time interval. The method is then operative to compare the sound level to a threshold value 430. If the sound level does not exceed the threshold value, the method is then operative to maintain or reinitiate the noise and vibration control 440 and return to sensing the sound level 420. If the sound level does exceed the threshold, the method is operative to remove or relax the noise vibration constraints 450 and return to sensing the sound level 420.

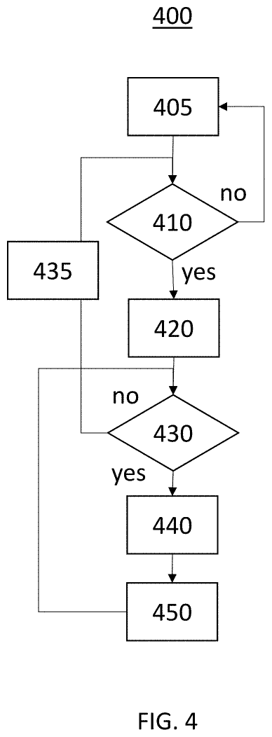

Turning now to FIG. 4, a flow chart illustrating another exemplary implementation of a method for interior noise sensing for efficient noise and vibration performance 400 is shown. Initially, the vehicle may be operating in a state where all systems are operating in the most efficient mode of operation 405. A vehicle system may then determine that the operational mode may be in a region where undesirable noise or vibration may be present, such as heavy system loading and operation of electronic cooling fans and electronic cooling pumps for reducing engine temperature under heavy load. The vehicle system may then apply noise and vibration constraints in order to reduce cabin noise and vibration by reducing fan noise and electric motor source excitation levels, but thereby reducing operating speeds or dithering the supply voltages in order to reduce fan noise and electric motor source excitation levels. While reducing cabin noise and vibration, these constraints have the undesirable effect of reducing vehicle performance and efficiency.

In this exemplary embodiment, the method is operative to determine if a noise constraint has been applied to a vehicle subsystem 410. If no noise constraint has been applied, the system returns to monitoring for noise constraints 410. If a noise constraint has been applied, the method is then operative to determine a sound level in a vehicle cabin 420. This determination of sound level may be made using microphones, vibration sensors, audio system volume settings, window state sensors, vehicle speed, HVAC fan settings and the like. The determination of the sound level may be made by multiple sound sensors and averaging the results, taking the highest level or the lowest level in different areas of the vehicle cabin.

The method is then operative to compare the determined sound level in the vehicle cabin to a threshold value 430. If the sound level does not exceed the threshold, the method returns to monitoring for noise constraints 410. The method may be operative to apply the noise constraint in response to the sound level not exceeding the threshold if the noise constraint is not currently applied 435 and a condition for noise constraint exists. If the sound level exceeds the threshold, the method is then operative to remove the noise constraint in response to the sound level exceeding a threshold 440. The vehicle and various vehicle subsystems are then operated in an absence of the noise constraint 450. The method may then be operative to determine if the sound level in the vehicle cabin 430 in order to determine if the sound level in the vehicle cabin has dropped to a level wherein the noise constraints should be initiated.

The exemplifications set out herein illustrate preferred embodiments of the invention, and such exemplifications are not to be construed as limiting the scope of the invention in any manner.

What is claimed is:

1. A method for generating a spatially rendering of an audio program comprising:
applying a noise control to a vehicle subsystem;
determining a cabin sound level;
comparing the cabin sound level to a threshold value;
removing the noise control in response to the cabin sound level exceeding the threshold value; and
operative the vehicle subsystem without the noise control.

2. The method of claim 1 wherein the vehicle subsystem is an electric drive motor.

3. The method of claim 1 wherein the noise control is a dithering frequency applied to a supply voltage of the vehicle subsystem.

4. The method of claim 1 wherein the cabin sound level is determined in response to a signal from a microphone within a cabin.

5. The method of claim 1 wherein the cabin sound level is indicative of an open vehicle window.

6. The method of claim 1 wherein cabin sound level is determined in response to an audio system volume level.

7. The method of claim 1 wherein the cabin sound level is determined in response to a first signal from a first microphone and a second signal from a second microphone, wherein the first microphone and the second microphone are located with a vehicle cabin.

8. An apparatus comprising;
a vehicle subsystem;
a first sound sensor for detecting a first cabin sound level at a first location and generating a first sound data signal;
a sound processor for receiving the first sound data signal and generated a control signal in response to the first sound data signal exceeding a threshold; and
a vehicle controller for controlling the vehicle subsystem, the vehicle controller further operative to remove a noise control restrain from the vehicle subsystem in response to the control signal.

9. The apparatus of claim 8 wherein the vehicle subsystem is an electric drive motor.

10. The apparatus of claim 8 wherein the noise control restraint is a dithering frequency applied to a supply voltage of the vehicle subsystem.

11. The apparatus of claim 8 further comprising:
A second sound sensor for detecting a second cabin sound level at a second location and generated a second sound data signal, and wherein the sound processor is operative to generate the control signal in response to the first sound data signal, the second sound data signal exceeding the threshold.

12. The apparatus of claim 8 wherein the cabin sound level is indicative of an open vehicle window.

13. The apparatus of claim 8 wherein cabin sound level is determined in response to an audio system volume level.

14. The apparatus of claim 8 wherein the cabin sound level is determined in response to a first signal from a first microphone and a second signal from a second microphone, wherein the first microphone and the second microphone are located with a vehicle cabin.

15. A method comprising;
operating a vehicle subsystem in response to a noise constraint;
determining a sound level in a vehicle cabin;
removing the noise constraint in response to the sound level exceeding a threshold; and
operating the vehicle subsystem in an absence of the noise constraint.

16. The method of claim 15 wherein the vehicle subsystem is an electric drive motor and the noise constraint is a dithering frequency applied to a supply voltage of the electric motor.

17. The method of claim 15 wherein the sound level is determined in response to an audio signal generated by a microphone within the vehicle cabin.

18. The method of claim 15 wherein the sound level is determined in response to an audio system volume level.

19. The method of claim 15 wherein the sound level is determined in response to a window state sensor and a vehicle speed.

20. The method of claim 15 wherein the sound level is determined in response to a first signal from a first microphone and a second signal from a second microphone, wherein the first microphone and the second microphone are located with the vehicle cabin.
